(19) United States
(12) Patent Application Publication
(10) Pub. No.: US 2001/0015126 A1
(43) Pub. Date: Aug. 23, 2001

(54) Multiple-barrel mortar assembly for launching grenades off the side of a combat vehicle

(76) Inventor: Jens Grunewald, Kassel (DE)

Correspondence Address: Ira J. Schaefer, Chadbourne & Parke LLP, 30 Rockefeller Plaza, New York, NY, 10112, US

(21) Appl. No.: 09/780,975

(22) Filed: Feb. 9, 2001

(30) Foreign Application Priority Data
Feb. 23, 2000 (DE) 100 08 198.3

(51) Int. Cl. F41F 5/00; B64D 1/04

(52) U.S. Cl. 89/1.41

(57) ABSTRACT

A multiple-barrel mortar assembly for launching grenades and similar items and mounted on the side of a combat vehicle. Several modules that can rotate in azimuth are mounted in a mount. Each mount is provided with a barrel accommodated in a block. Each barrel extends at a prescribed acute angle to the base of the block. The angle establishes the assembly's elevation. Each block is secured in a frame. The frame can rotate around an axis perpendicular to the base of the block. A drive mechanism can rotate all the frames simultaneously through a prescribed range of angles around the axis.

### BACKGROUND OF THE INVENTION

The present invention concerns a multiple-barrel mortar assembly for launching smoke grenades, explosive grenades, and similar items (e.g., IR foggers, Softkill, and flares) off the side of a combat vehicle. The grenades are accommodated in barrels, which are in turn accommodated in blocks at a prescribed angle to the block's base that establishes the mortar assembly's elevation. The blocks, finally, are accommodated in a mount fastened to the side of the vehicle. The grenades can be fired out of the barrels by explosive charges.

Multiple-barrel mortar assemblies of this genus are in themselves known, and the barrels are described in German 2420862 A1 and 3706213 A1 and Austrian 330 030 for example.

The barrels in these known multiple-barrel mortar assemblies are secured rigidly, either individually or several together in a stationary accommodation, to the side of the vehicle. The barrels in mortar assemblies that include several are secured at prescribed fixed azimuthal angles to each other and, although the grenades can be fired out of the individual barrels in an array, the direction of the array can be changed only by turning the vehicle or its turret.

Also known is a mortar assembly whereby several barrels are accommodated stationary and parallel in a mount that can as a whole be pivoted in azimuth on the side of the vehicle. An array is possible only by firing off the grenades at intervals and pivoting the overall mount in azimuth between the intervals. This approach entails tactical drawbacks. The mortar assembly is also rather large and difficult to integrate into the vehicle's silhouette.

### SUMMARY OF THE INVENTION

The object of the present invention is accordingly a multiple-barrel mortar assembly of the aforesaid genus whereby the individual barrels can be aimed to allow a simultaneous array of the grenades and whereby the array can be aimed in different directions without turning either the vehicle or the turret.

This object is attained in accordance with the present invention in a multiple-barrel mortar assembly of the aforesaid genus in that every barrel block in the mount fastened to the side of the vehicle can rotate around an axis perpendicular to the base of the block and by at least one drive mechanism that rotates the block a prescribed range of angles around that axis.

The theory behind the present invention is to accommodate the generally several barrels either in one and the same block or each in an individual frame, whereby the block or frame can rotate in azimuth on the side of the vehicle, allowing each barrel to be rotated by a drive mechanism into a desired angle in azimuth.

Since considerable recoil is released when a grenade is fired, it has been demonstrated of great advantage to the stability of the contrivance for the block and barrel to be accommodated in their associated mount with the effective axis of the barrel intersecting the axis of rotation of the frame. This approach will eliminate the effects of momentum on the aiming mechanism.

The stability of the mortar assembly can be further increased if every barrel block or frame in the mount fastened to side of the vehicle is mounted at two points along the axis of rotation below the block and above the barrel.

It has been demonstrated practical for the center of mass of the block and barrels to be located along or in the immediate vicinity of the axis of rotation.

In principle, all the barrels on one and the same combat vehicle can accordingly be individually aimed in azimuth. Since, however, several barrels are usually combined into a single mortar assembly such that the grenades can be fired fanned out at prescribed angles, it has been demonstrated practical for several barrels or several modules comprising barrels, block, and frame to be mounted horizontally adjacent, vertically adjacent, or both in a mount fastened to the side of the vehicle, whereby the barrels are all separated by prescribed angles in azimuth and can be rotated simultaneously by the same drive mechanism and whereby each barrel can be rotated a prescribed range of angles in azimuth without varying the angle between the individual barrels.

The present invention accordingly represents a directable multiple-barrel mortar assembly that will allow expansion of the effective array or of multiple firing in the same effective direction and that will feature the advantages in accordance with its particular embodiment now to be described.

a) A directable array of up to 220° in azimuth can be attained at a fixed elevation of 22 to 45°.

b) The mortar assembly can be aimed very rapidly at low moments of mass inertia, with, that is, the barrel rotated tight around its center of mass.

c) The potential for a neutral symmetrical flow of forces through the barrels, center of rotation prevents destructive consequential loads on the drive mechanism.

d) Every barrel, whether horizontally or vertically aligned, can be provided with a stable two-point suspension.

e) With several barrels within a single module rotated simultaneously, the drive mechanisms can be simple—rack and pinion, cogwheel segment, connecting rod with flat-surfaced wheel between segments, or direct drive (incremental motor) for instance.

f) The mortar assembly can be modular in design and accordingly expandable as needed.

g) Existing mortar assemblies can be retrofit and attached to existing interfaces.

h) The barrels in one module can be pivoted into a traveling state in the zero position within the vehicle's silhouette.

i) The barrel frames can be driven by hollow shafts with electrical cables for igniting the barrels extending through the shafts.

The multiple-barrel mortar assembly in accordance with the present invention can be controlled automatically by way of sensors, periscopes, video cameras, or infrared cameras. It can also be controlled manually with a tip sight or sector switch.

Embodiments of a multiple-barrel mortar assembly in accordance with the present invention will now be specified with reference to the drawing, wherein

### BRIEF DESCRIPTION OF THE DRAWINGS

FIG. 1 is a lateral view of a single barrel accommodated in a frame,

FIG. 2 is an overhead view of the barrel illustrated in FIG. 1,

FIG. 3 is a view of the barrel from below,

FIG. 4 is a front view of the barrel,

FIG. 5 is a perspective view of the barrel illustrated in FIGS. 1 through 4,

FIG. 6 is a front view of a module comprising four barrels aligned horizontally and of their frames,

FIG. 7 is a view of the module illustrated in FIG. 6 from below,

FIG. 8 is an overhead view of the same module,

FIG. 9 is a perspective view of the module with the barrels aimed in a particular direction,

FIG. 10 is a lateral view of the same module aimed as illustrated in FIG. 9,

FIG. 11 is a perspective view similar to that in FIG. 9 of the module illustrated in FIG. 6 but aimed in a different direction,

FIG. 12 is a front view of a module with vertically aligned barrels,

FIG. 13 is an overhead view of the module illustrated in FIG. 12,

FIG. 14 is a view from below of the module illustrated in FIG. 12,

FIG. 15 is a lateral view of the module illustrated in FIG. 12,

FIG. 16 is a perspective view of the module illustrated in FIG. 12,

FIG. 17 is an overhead view of a military tank with two multiple-barrel mortar assemblies mounted on its turret,

FIG. 18 is an overhead view of a military tank with a multiple-barrel mortar assembly mounted on its stern,

FIG. 19 is a front view of a module comprising six barrels in three blocks,

FIG. 20 is a perspective view of the module illustrated in FIG. 19,

FIG. 21 is a front view of a module comprising eight barrels in two blocks, and

FIG. 22 is a perspective view of the module illustrated in FIG. 21.

### DETAILED DESCRIPTION OF THE INVENTION

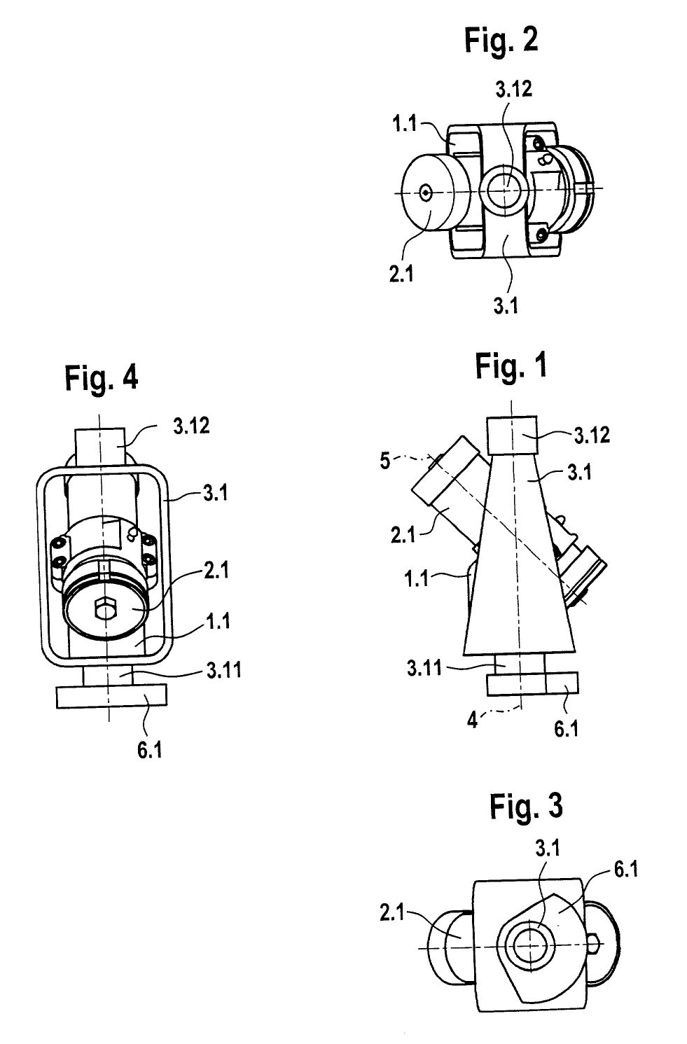

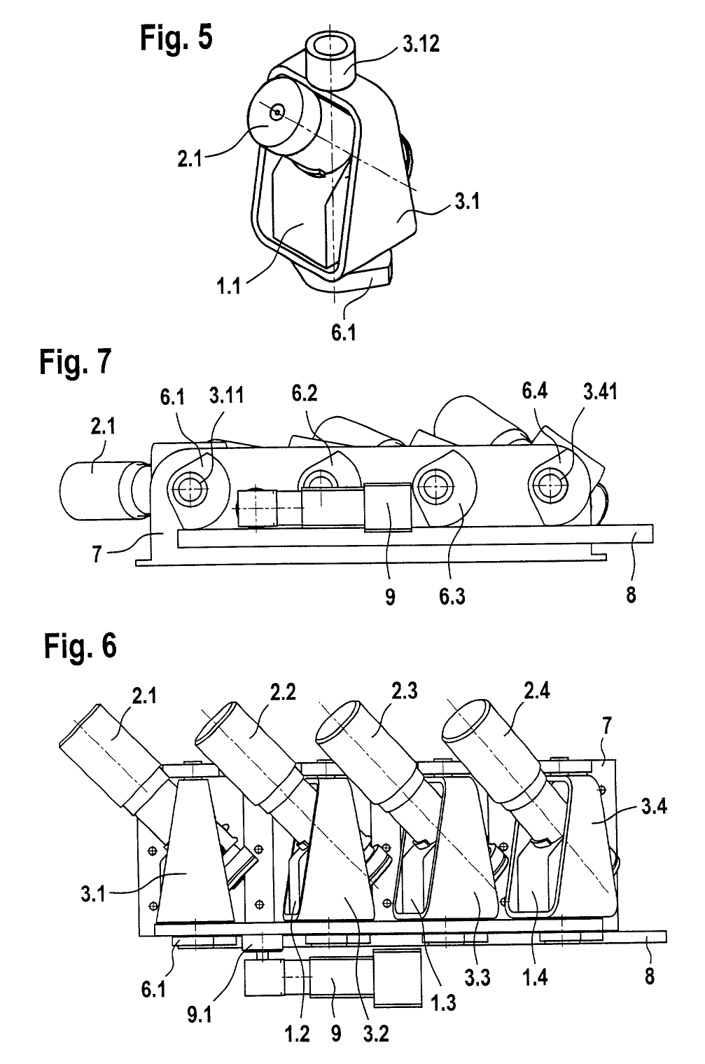

FIGS. 1 through 5 illustrate a mortar with a conventional barrel 2.1 accommodated in a block 1.1 with its effective axis 5 at an angle to the base of the block. This angle is prescribed and dictates the barrel's elevation. Block 1.1 and barrel 2.1 are both fastened in a frame 3.1 that encloses barrel block 1.1 at its base, sides, and top, accordingly also enclosing barrel 2.1 along with it. A hollow shaft 3.11 is positioned at the bottom, and another, 3.12, at the top of frame 3.1. The aligned axes of shafts constitute the axis 4 of rotation of frame 3.1, several of which will be specified hereinafter. On the free end of lower shaft 3.11 is a cogwheel segment 6.1 which will also be specified hereinafter.

Barrel 2.1 and frame 3.1 are mutually associated such that effective axis 5 and the axis of rotation intersect with the center of mass of barrel block 1.1 and barrel 2.1 and lie along the axis 4 of rotation of frame 3.1.

The module comprising barrel block 1.1 and frame 3.1 specified with reference to FIGS. 1 through 5 can be combined in many ways with similar modules into a multiple-barrel mortar assembly.

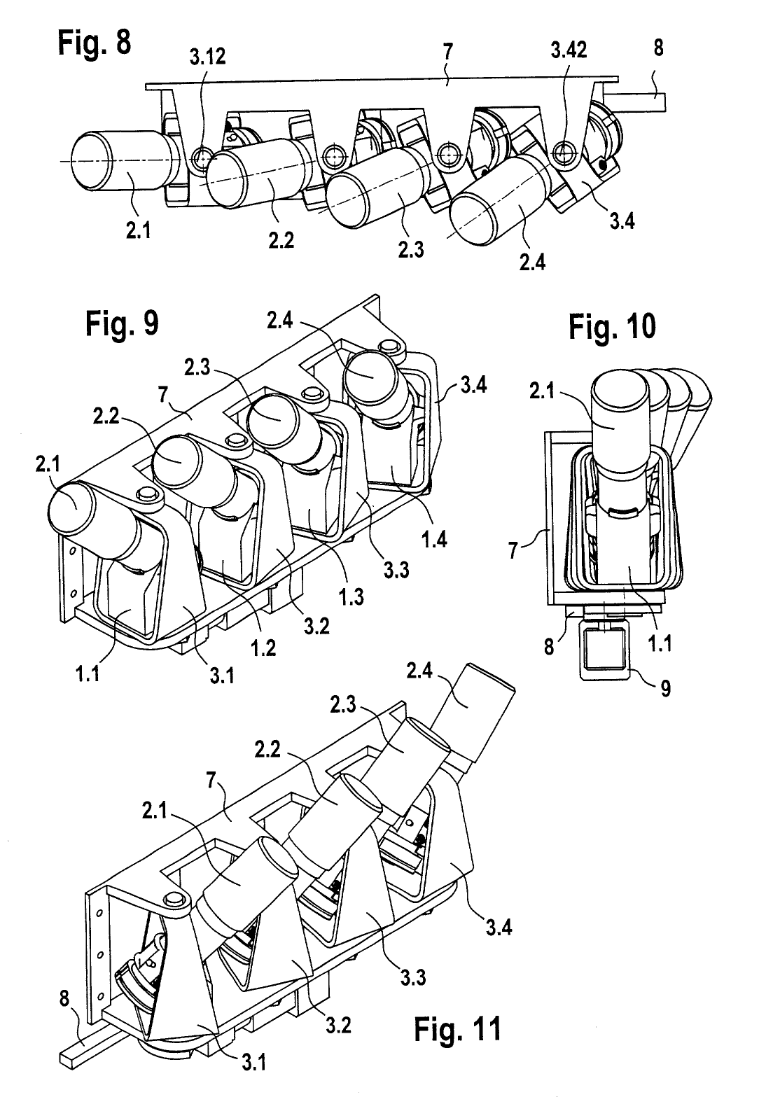

One possible embodiment will now be specified with reference to FIGS. 7 through 11.

The mortar assembly illustrated in FIGS. 7 through 11 is composed of four adjacent modules of the type illustrated in FIGS. 1 through 5. Each module comprises a barrel block 1.1-1.4, a barrel 2.1.-2.4, a frame 3.1.-3.4, and hollow shafts 3.11-3.41 and 3.12-3.42. Cogwheel segments 6.1-6.4 are attached to the lower shafts. These modules rotate in an essentially U-shaped mount 7. The modules are accommodated in mount 7 with lower shafts 3.11-3.41 and upper shafts 3.12-3.42 rotating therein around parallel axes. Every module is suspended in mount 7 at two points along the axis 4, one below the barrel block and one above the barrel. The cogwheel segments 6.1.-6.4 mounted on the lower shafts are below the bottom of mount 7 and mesh with a rack 8 that extends along the bottom and travels in an unillustrated manner in relation to mount 7. Also engaging rack 8 is a take-off pinion 9.1, a component of a stationary motor 9. As will be evident from the figure, rack 8 can be activated by motor 9, rotating frames 3.1-3.4 around their axes 4 (FIG. 1) of rotation by way of cogwheel segments 6.1-6.4. As will be evident from FIGS. 7 through 11, frames 3.1-3.4 are accommodated in mount 7 such that the effective axes 5 (FIG. 1) of barrels 2.1-2.4 are at a constant angle in azimuth to each other. This angle can for example be 120. The angle that every barrel 2.1-2.4 can range through, starting from zero, can for example be 2200 of azimuth. FIGS. 9 and 11 illustrate the limiting position of barrels 2.1-2.4.

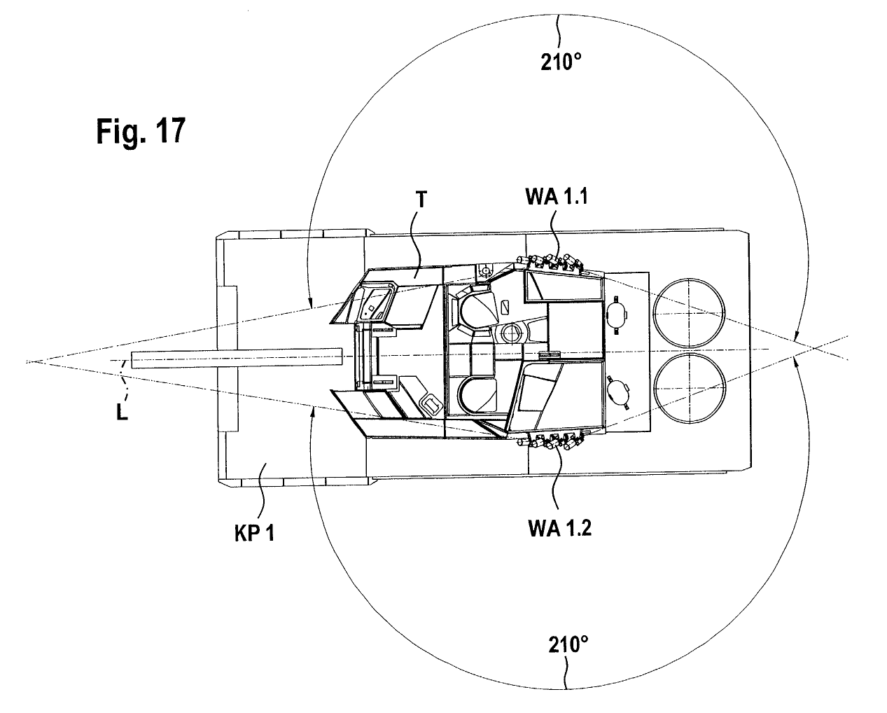

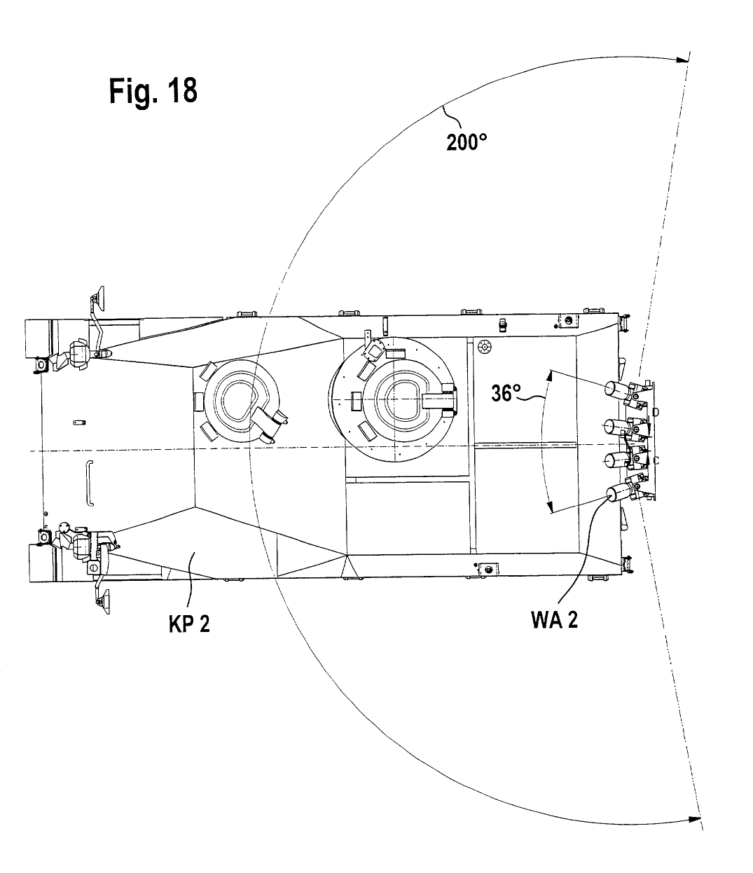

Mount 7 is fastened to a combat vehicle along with the modules accommodating barrels 2.1-2.4, the base of the mount extending horizontal. FIGS. 17 and 18 illustrate examples.

FIG. 17 is a schematic illustration of a military tank KP1 with a rotating turret T. Multiple-barrel mortar assemblies WA1.1 and WA1.2 are mounted on the sides of tank KP1, one on each side of its longitudinal axis L. These mortar assemblies can fire grenades to each side in a total array of 210°.

FIG. 18 illustrates another embodiment with a multiple-barrel mortar assembly WA2 fastened to the stern of a light military tank KP2. Grenades can be fired from this vehicle in an array of 200° along the direction of travel.

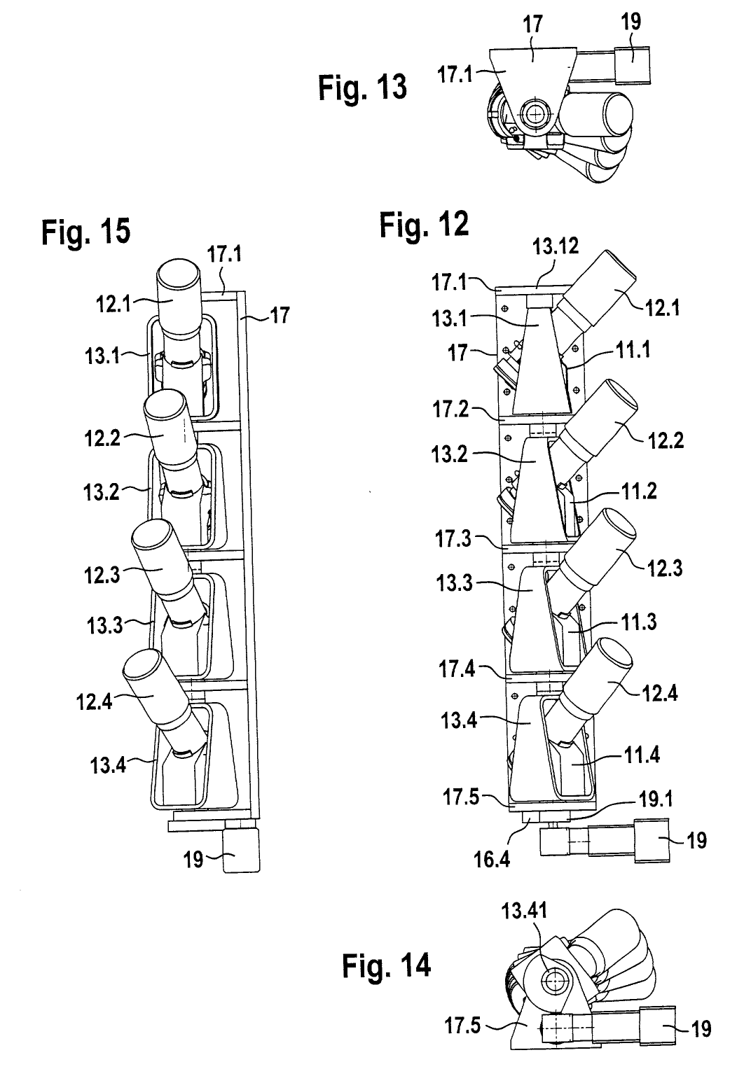

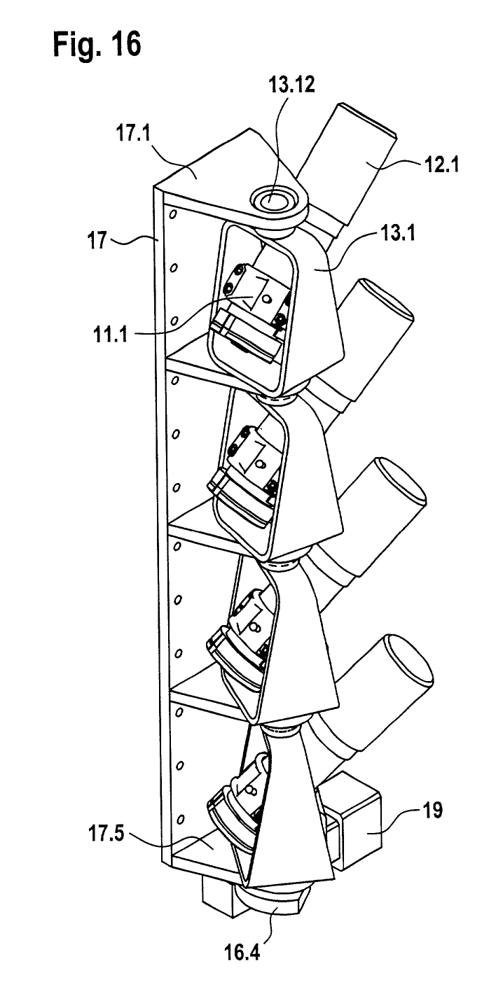

FIGS. 12 through 16 illustrate another approach to combining the modules illustrated in FIGS. 1 through 5 into an overall multiple-barrel mortar assembly.

In this embodiment four modules are mounted together one above another by unillustrated means in a mount 17 fastened vertically to the vehicle. Each module comprises barrels 12.1-12.4, barrel blocks 11.1-11.4, and frames 13.1-13.4. The axes (4 in FIG. 1) of rotation of frames 13.1-13.4 are aligned. Mount 17 is provided with brackets 17.1-17.5, one above another, between which the individual modules are accommodated and on which shafts 13.12 (FIG. 12)-13.41 (FIG. 14) are mounted. The uppermost shaft in each frame is coupled to the lowermost shaft of the next highest frame component. Mounted on the lowest shaft 13.41 is a cogwheel segment 16.4 that is engaged by the take-off shaft 19.1 of a motor 19. As will be evident from FIGS. 13 through 16, the modules are accommodated in mount 17 such as to ensure that barrels 12.112.4 are at a constant angle of 120 to one another. When motor 19 is activated cogwheel segment 16.4 will rotate frames 13.113.4 and hence barrels 12.1-12.4 simultaneously around the same angle in azimuth.

The electric cables extending from the vehicle to the devices that ignite barrels 12.1-12.4 all pass through the hollow shaft. The cables that lead to the other barrels in frames 13.1-13.4 extend unillustrated between barrel blocks 11.1-11.4 and the inner surface of frames 13.1-13.4.

Although the feature is not illustrated, the drive mechanisms in both illustrated embodiments can be dimensioned and distributed such that every frame 3.1-3.4 and 13.1-13.4 can be pivoted out of the zero-azimuth position and into a traveling position with the barrels 2.1-2.4 and 12.1-12.4 within the vehicle's prescribed silhouette.

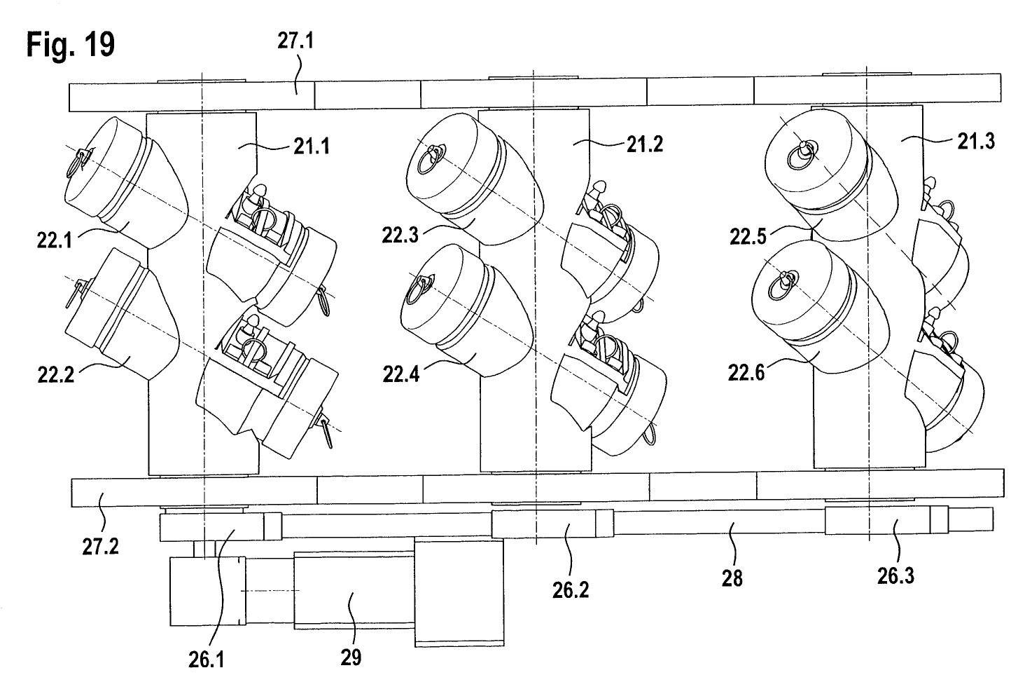

FIGS. 19 through 22 illustrate other embodiments wherein, instead of modules comprising barrel blocks, barrels, and frames, several barrels stacked in columnar blocks that can rotate in a frame fastened to the vehicle, each block being rotated by the drive mechanism.

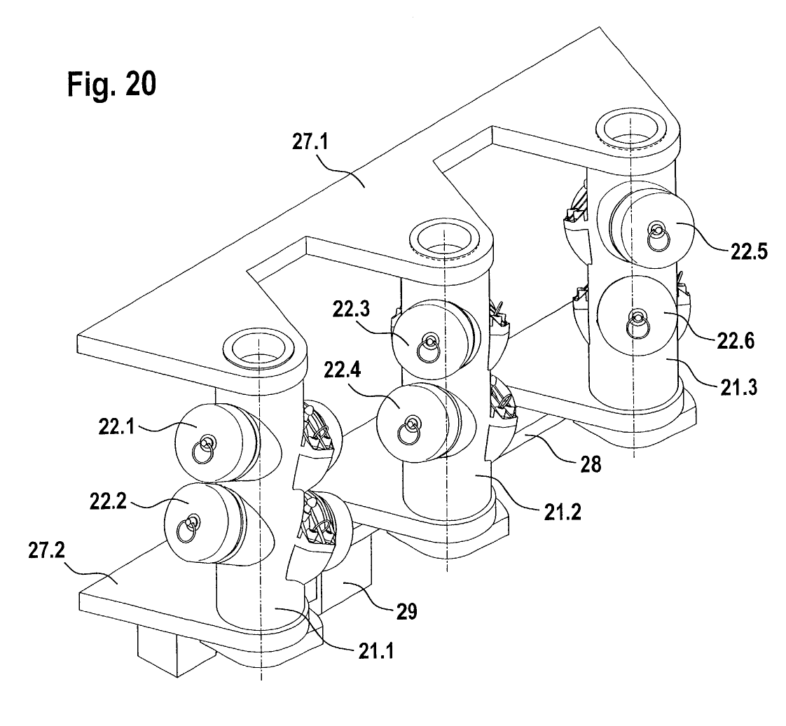

FIGS. 19 and 20 illustrate an embodiment wherein three barrel blocks 21.1-21.3 can rotate on a mount 27.1 and 27.2 fastened to the vehicle. Three barrel blocks 21.1-21.3 can rotate in the frames 27.1 and 27.2 fastened to the vehicle in the embodiment illustrated in FIGS. 19 and 20. Barrels 22.1 and 22.2 are accommodated one above the other in barrel block 21.1, barrels 22.3 and 22.4 one above the other in barrel block 21.2, and barrels 22.5 and 22.6 one above the other in barrel block 21.3. Cogwheel segments 26.1-26.3 are accommodated in barrel blocks 21.1-21.3 below the bottom of mount 27.2. Barrel blocks 21.1-21.3 can rotate on vertical and parallel axes. Every block is mounted on its shaft at two points above and below the barrels. Cogwheel segments 26.126.3 mesh with a rack 28 that extends along the bottom, where it can be displaced in relation to lower frame 27.2. The rack 28 is also engaged by the take-off pinion of a stationary motor 29. Motor 29 displaces rack 28, rotating cogwheel segments 26.1-26.3 and hence barrel blocks 21.1-21.3.

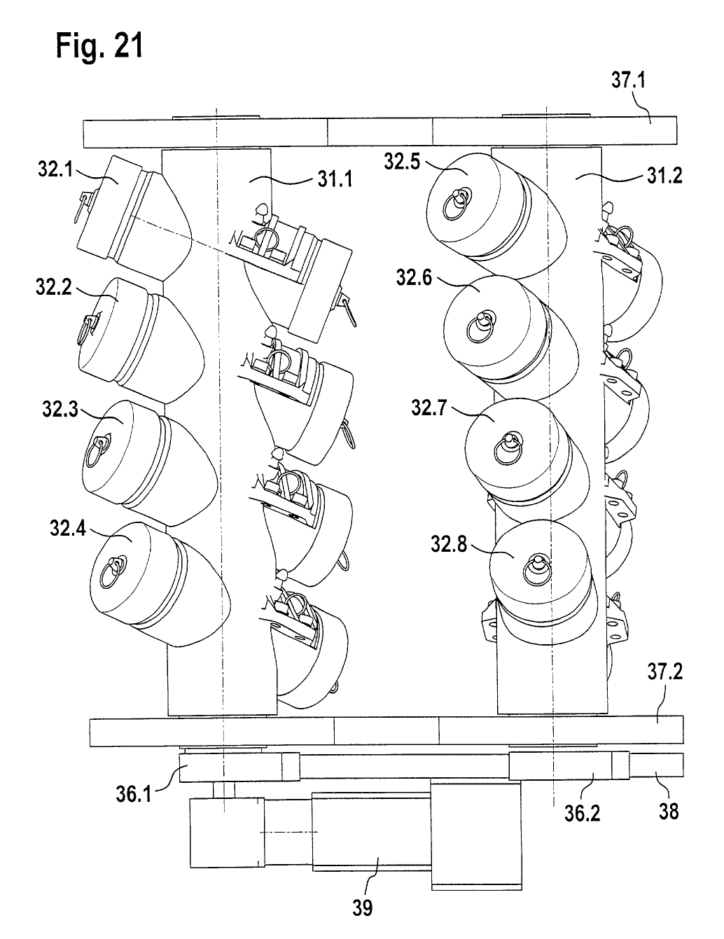

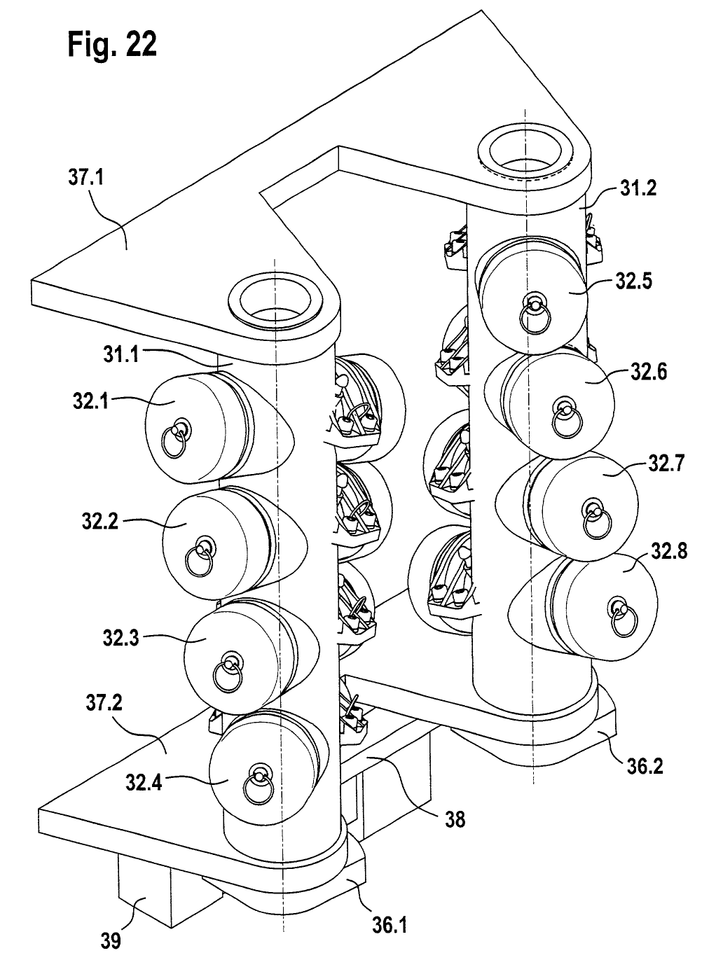

As shown in FIGS. 21 and 22, two barrel blocks 31.1 and 31.2 can rotate in a mount fastened to the side of the vehicle and comprising components 37.1 and 37.2. Each block 31.1 and 31.2 accommodates four barrels 32.1-32.4 and 32.5-32.8. As will be evident from the drawing, the barrels in each block 31.1-31.2 are at the same prescribed angle in azimuth to one another. Blocks 31.1 and 31.2 are connected to cogwheel segments 36.1 and 36.2 accommodated below lower mount component 27.2. Segments 36.1. and 36.2 engage a rack 38 that can be displaced by the take-off pinion of a motor 39, which in this embodiment as well activates both barrel blocks 31.1 and 31.2 simultaneously.

The multiple-barrel mortar assemblies illustrated in FIGS. 19 through 22 can, like the ones illustrated in FIGS. 17 and 18, be mounted on a military tank.

It is understood that the embodiments described hereinabove are merely illustrative and are not intended to limit the scope of the invention. It is realized that various changes, alterations, rearrangements and modifications can be made by those skilled in the art without substantially departing from the spirit and scope of the present invention.

What is claimed is:

1. A multiple-barrel mortar assembly for launching grenades and mountable on the side of a combat vehicle, wherein the grenades are accommodated in barrels, the barrels are accommodated in blocks at a prescribed angle to a base of the block that establishes an elevation of the mortar assembly, the blocks are accommodated in a mount fastenable to a side of the vehicle, and the grenades can be fired out of the barrels by explosive charges, wherein every barrel block in the mount fastenable to the side of the vehicle can rotate around an axis perpendicular to the base of the block, and further comprising at least one drive mechanism that rotates the block a prescribed range of angles around that axis.

2. The mortar assembly as in claim 1, wherein every barrel block is secured at the top and sides and below the bottom in a frame, wherein every frame can rotate in the mount around an axis perpendicular to the base of the block and can be rotated a prescribed angle around that axis by the drive mechanism.

3. The mortar assembly as in claim 1 or 2, wherein the barrel block and the barrel are accommodated in the in the mount or in the frame with the effective axis of the barrel intersecting the axis of rotation of the frame.

4. The mortar assembly as in claim 1 or 2, wherein every barrel block or frame in the in the mount is mounted at two points along the axis of rotation below and above the barrel or barrels.

5. The mortar assembly as in claim 2, wherein the center of mass of the block and barrel or barrels is located along or in the immediate vicinity of the axis of rotation of the block or frame.

6. The mortar assembly as in claim 2, wherein every frame is driven by a hollow shaft, through which the electric cables leading from the vehicle to an ignition systems of the barrel extend.

7. The mortar assembly as in claim 2, further comprising several modules, each comprising a barrel, a barrel block, and a frame, are accommodated adjacent in a mount fastened to the vehicle essentially horizontal, with the distances between the axes of rotation of the frames, and all driven simultaneously by the same drive mechanism.

8. The mortar assembly as in claim 7, further comprising on the top or bottom of every barrel block or frame, cogwheel segments that mesh with one and the same horizontal rack, which slides back and forth above or below the mount and is actuated by the drive mechanism.

9. The mortar assembly as in claim 7, further comprising on the top or bottom of every frame, pinions that mesh with one and the same horizontal driveshaft above or below the mount and couple the shaft to the drive mechanism.

10. The mortar assembly as in claim 8 or 9, wherein the drive mechanism is a motor that actuates the rack or common driveshaft by way of a transmission.

11. The mortar assembly as in claim 2, further comprising several modules, each comprising a barrel, a barrel block and a frame, and which are accommodated one above another in a mount fastenable essentially vertical to the vehicle with the axes of rotation of the frames in alignment, and which can be simultaneously actuated by one and the same drive mechanism.

12. The mortar assembly as in claim 11, wherein the top and bottom of each frame is provided with a hollow shaft, the shafts in adjacent frames being coupled together and the electric cables running from the vehicle to the barrels extending through the shafts and, within the frames, between the barrel block and the frame.

13. The mortar assembly as in claim 12, wherein the single drive mechanism is a motor that actuates either the uppermost or the lowermost hollow shaft in the assembly by way of a transmission.

14. The mortar assembly as in claim 7, wherein the frames are secured in the mount with the barrels at a prescribed identical angle in azimuth to one another at any stage of simultaneous rotation.

15. The mortar assembly as in claim 1, wherein either every barrel block or every frame can be pivoted out of the zero-azimuth position and into a traveling position with the barrels within the vehicle's silhouette.
